(19) United States
(12) Patent Application Publication
(10) Pub. No.: US 2014/0153254 A1
(43) Pub. Date: Jun. 5, 2014

(54) LAMP WITH INTEGRATED ELECTRONICS AND THERMALLY PROTECTIVE FEATURES

(71) Applicant: GENERAL ELECTRIC COMPANY, Schenectady, NY (US)

(72) Inventors: Márton Nedermann, Budapest (HU); Ferenc Fazekas, Piliscsaba (HU); Géza Zoltán Cseh, Budapest (HU); Péter Jezsoviczki, Budapest (HU)

(73) Assignee: GENERAL ELECTRIC COMPANY, Schenectady, NY (US)

(21) Appl. No.: 13/693,228

(22) Filed: Dec. 4, 2012

(51) Int. Cl. F21V 7/22; F21V 15/01

(52) U.S. Cl. CPC F21V 7/22; F21V 15/01
USPC 362/310; 362/363

(57) ABSTRACT

A lamp assembly is provided having one or more features for protecting an electronics package that is positioned outside of the evacuated space of a bulb containing a light emitting device such as an HID or halogen burner capsule. For example, the bulb can be evacuated and hermetically sealed to minimize heat transfer from the light emitting device. One or more reflective surfaces can be provided to reflect radiant energy from the light emitting device away from the electronics package. One or more insulating components can be positioned between the electronics package and the light emitting device.

### FIELD OF THE INVENTION

The subject matter of the present disclosure relates generally to a lamp having one or more features that provide thermal protection to electronic components of the lamp.

### BACKGROUND OF THE INVENTION

Light emitting devices or light sources are available that can provide a higher output of light with greater efficiency than the traditional incandescent filament. For example, a halogen burner uses a capsule or sealed tube containing an incandescent element and a halogen gas to provide a more efficient light source that can also have a higher color temperature than an incandescent light source. A high intensity discharge (HID) burner uses e.g., a tungsten element inside a capsule or sealed tube containing a gas and one or more metal salts to provide a light source that can provide a greater portion of visible light per unit of energy than an incandescent light source.

However, halogen and HID type light emitting devices present certain heat management issues. A lamp or lighting device using halogen or HID will typically include electronics such as an integrated electrical transformer to convert a supply or line voltage to the working voltage for powering the burner. Unfortunately, such electronics can also be damaged by the thermal and radiant energy created by the halogen or HID burner. For example, these burners generate infrared radiation that can damage the electronics by e.g., causing the electronics package to overheat.

Damage to the electronics package will typically shorten the useful life of lamp. Such can be undesirable not only for consumers but also for premature disposal of the lamps once they become non-functional. While a non-functioning burner may be replaceable, lamps are typically not constructed in a manner that allows the consumer to readily replace the electronics package.

Requirements have been promulgated that require certain lamps to have a minimum useful life. For example, European Union Commission Regulation (EC) No. 244/2009 of implementing directive 2005/32/EC requires that after Jan. 1, 2016, non-directional lamps for household use must have a useful life of at least 2000 hours and have certain energy efficiency. Other regulations may apply in different countries.

Accordingly, a lamp assembly with an improved useful life would be beneficial. More specifically, a lamp assembly that can use e.g., a halogen or HID light emitting source and that incorporates one or more features for protecting the electronics from damage to such light source would be useful. Such a lamp assembly that can be provided within the commonly used lamp sizes and styles would also be beneficial.

### BRIEF DESCRIPTION OF THE INVENTION

The present invention provides a lamp assembly having one or more features for protecting an electronics package that is positioned outside of an evacuated bulb containing a light emitting device such as an HID or halogen burner capsule. For example, the bulb can be evacuated and hermetically sealed to minimize heat transfer from the light emitting device. One or more reflective surfaces can be provided to reflect radiant energy from the light emitting device away from the electronics package. One or more insulating components can be positioned between the electronics package and the light emitting device. Such features can reduce the temperature increase that would otherwise be experienced by the electronics package and thereby improve the useful life of the lamp. Additional aspects and advantages of the invention will be set forth in part in the following description, or may be apparent from the description, or may be learned through practice of the invention.

In one exemplary embodiment, the present invention provides a lamp assembly that includes a base with a housing positioned proximate to the base. The housing has an internal surface and defines an interior compartment. A bulb is supported by the housing and defines an enclosed and evacuated space. A light emitting device is positioned within the enclosed space of the bulb. An electrical unit is received into the interior compartment of the housing and is positioned external to the evacuated space of the bulb. The electrical unit is connected electrically with the light emitting device.

In another exemplary embodiment, the present invention provides a thermally protected lamp assembly that includes a housing defining an interior compartment. A bulb is provided having a base portion and a body portion. The bulb defines an enclosed volume that is evacuated. The base portion of the bulb is received within the interior compartment of the housing. An electronics package is received into the interior compartment of the housing and is located outside of the enclosed volume of the bulb. A light emitting device is positioned within the enclosed volume of the bulb and is connected with the electronics package.

In another exemplary embodiment, the present invention provides a lamp assembly that includes a bulb defining an enclosed and evacuated space. A housing is positioned proximate to the bulb. The housing has an interior compartment. A base is connected with the housing. A lighting emitting device is positioned within the bulb so as to project light through the enclosed and evacuated space. An electrical unit is received into the interior compartment of the housing and located external to the enclosed and evacuated space of the bulb. The electrical unit is connected electrically with the light emitting device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a lamp assembly of the present invention.

FIG. 2 is an exploded view of the exemplary embodiment of FIG. 1.

FIG. 3 is a cross-sectional view of another exemplary embodiment of a lamp assembly of the present invention.

FIGS. 4 and 5 are plots of certain experimental data as further described herein.

FIGS. 6-10 provide side views of additional exemplary embodiments of the present invention.

The use of the same references numerals among different figures denotes the same or similar features.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

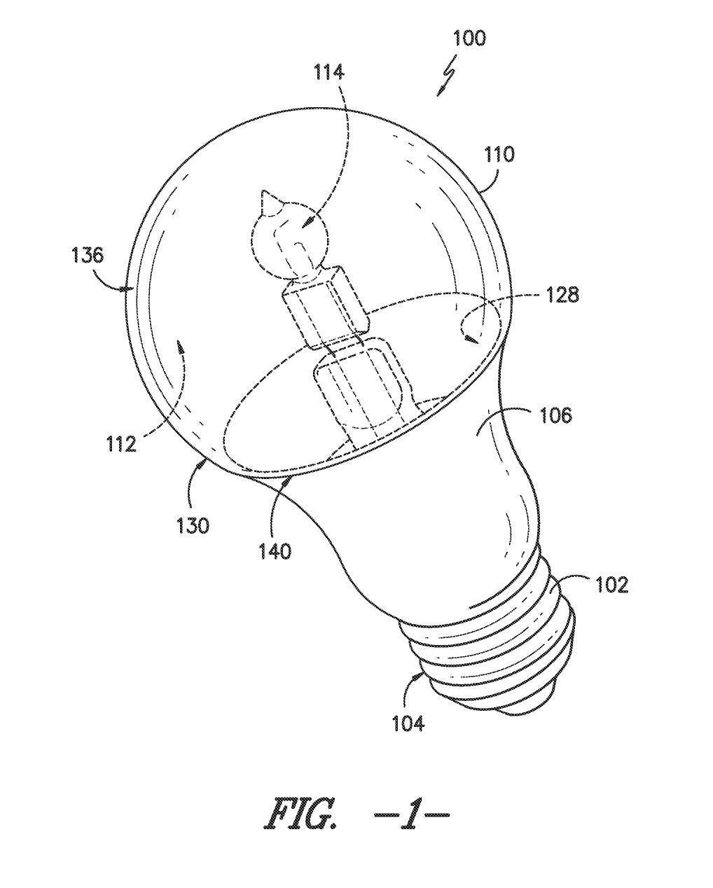

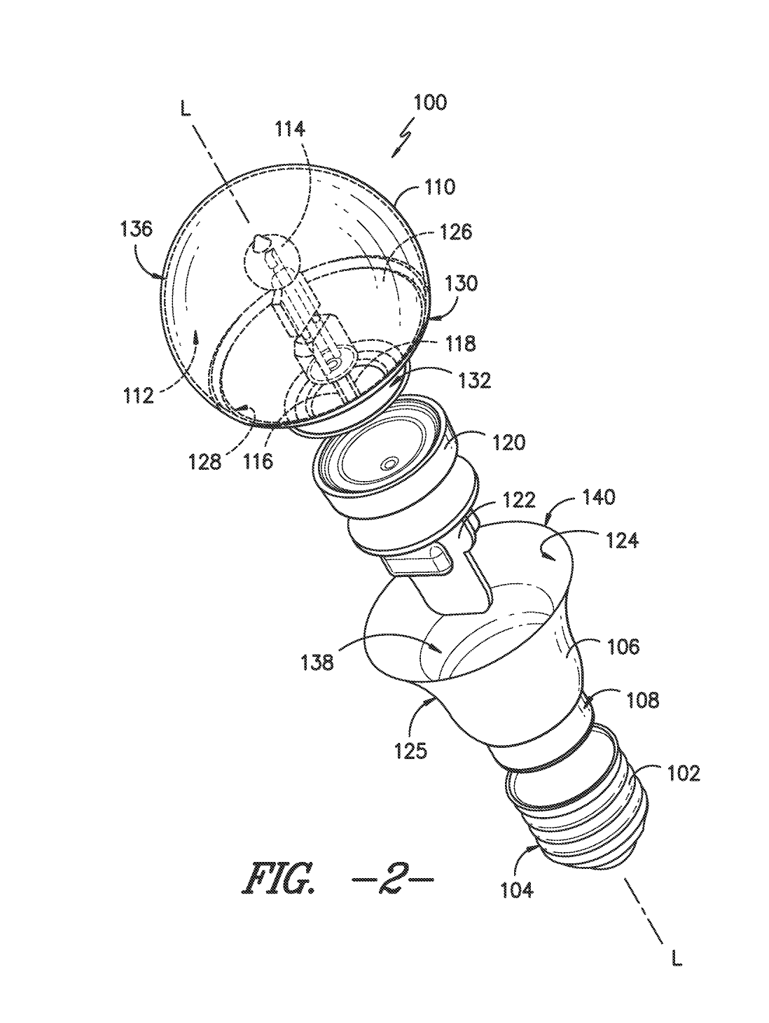

FIG. 1 illustrates an exemplary embodiment of a lamp assembly 100 of the present invention in a perspective view while FIG. 2 provides an exploded view of the same. Lamp assembly 100 includes a base 102 with threads 104 (commonly referred to as an “Edison base”). Base 102 allows lamp assembly 100 to be positioned in e.g., a light fixture and connected with an electrical power source. Base 102 and threads 104 are provided by way of example only. For example, other types of bases with different features may be used as well.

A housing 106 is connected to base 102. For this exemplary embodiment, housing 106 includes a recessed annular portion 108 for receipt into base 102. Other configurations for connecting base 102 and housing 106 may be used as well. Housing 106 has an internal surface 124 and defines an interior compartment 138. By way of example, housing 106 may be constructed from a plastic material.

A bulb 110 is connected with or supported by housing 106. Bulb 110 defines an enclosed space 112 that is evacuated. For example, space 112 may be under a vacuum in the range of about 100 milli-bar (mbar) or less. During manufacture, bulb 110 can be hermetically sealed to retain the vacuum and seal out e.g., ambient air. By way of example, bulb 110 may be constructed from a translucent or transparent material such as glass. One or more coatings may also be applied to the glass to e.g., diffuse the emitted light or change other properties of the light. A variety of shapes may be used for bulb 110 including e.g., A60, A55, B35, and others.

A light emitting device 114 is positioned within the enclosed and evacuated space 112 of bulb 110. Light emitting device 114 may be e.g., a halogen, incandescent, discharge, HID burner capsule, or others. The advantages of these types of light emitting devices over traditional incandescent light sources were previously discussed. In certain exemplary embodiments, light emitting device 114 may be based on an incandescent type light source as well.

Light emitting device 114 includes at least a pair of electrodes 116 and 118 for electrical connection with an electrical unit or electronics package 122. This electronic package 122 is electrically connected with base 102 for this exemplary embodiment. Electronics package 122 includes an electrical transformer that changes the line voltage received by base 102 into a working voltage needed to power light emitting device 114. As shown, the electronics package 122 is received into the interior compartment 138 provided by housing 106 and is not located within the evacuated and enclosed space 112 of bulb 110. The present invention is not limited to the shape of the electronics package 122 shown in the figures. Other shapes and configurations may be shown as well.

Bulb 110 includes a body portion 136 and a base portion 132. Base portion 132 is received into the interior compartment 138 of housing 106. By way of example, base portion 132 may be adhered to housing 106. Other techniques for connecting base portion 132 and housing 106 may be used as well.

Base portion 132 is provided with reflective coating 126 that may be located on the inside surface 128 or outside surface 130 of bulb 110. The reflective coating is constructed from one or more materials that reflect radiant energy created by light emitting device 114. More specifically, the reflective coating helps reflect such radiant energy away from the electronics package 122. Base portion 132 of bulb 110 can also be shaped as shown to help reflect radiant energy of lighting emitting device 114 away from package 122. Internal surface 124 of housing 106 can also be shaped to help reflect light away from package 122 when constructed from, or covered with, a reflective material.

A variety of materials may be used for the reflective coating 126 or a similar coating applied on housing 106. For example, reflective coating 126 may include aluminum oxide, silver, aluminum, tin, tin dioxide, boron nitride, other reflective metals, polycarbonate, polyethylene, polyethylene terephthalate, polytetrafluorethylene, other reflective plastics, and combinations thereof. The reflective coating may also be provided with a mirror-like finish to improve its ability to reflect. The coating may also be constructed from a material specially selected to reflect e.g., infrared radiation from light emitting device 114.

For this exemplary embodiment, the width (or height) of reflective coating 126 along longitudinal direction L is such that coating 126 does not extend beyond the base portion of bulb 100 or outside of housing 106. For example, reflective coating 126 does not extend past the edge 140 of housing 106 where it would impede the passage of visible light through bulb 110.

Together, the evacuated space 112 of bulb 110 and the reflective coating 126 help reduce the temperature that would otherwise be experienced by electronics package 122. More specifically, the vacuum inside bulb 110 helps prevent heat transfer by convection from the light emitting device to the exterior of bulb 110—including electronics package 122. Radiant energy that would otherwise heat the electronics package either directly or indirectly (by heating housing 106) is reflected away by the reflective coating 126. Alternatively, or in addition thereto, a reflective coating on the internal surface 124 and/or outside surface 125 of housing 106 can also be provided to reflect such radiant energy as well. Housing 106 may also be constructed from a reflective material such as e.g., a reflective polymer.

Lamp assembly 100 can also include an insulating element or thermal shield 120 that is located between the light emitting device 114 and the electronics package 122. For this exemplary embodiment, shield 120 is constructed with a disc-like shape that is positioned over electronics package 122. Shield 120 provides thermal protection of the electronics package 122 from the radiant and thermal energy released by light emitting device 114. For example, shield 120 can be constructed from a thermoplastic material having a melting point of about 150° C. or higher. Alternatively, or in addition thereto, a potting material can be provided in housing 106 to provide further insulation of electronics package 122.

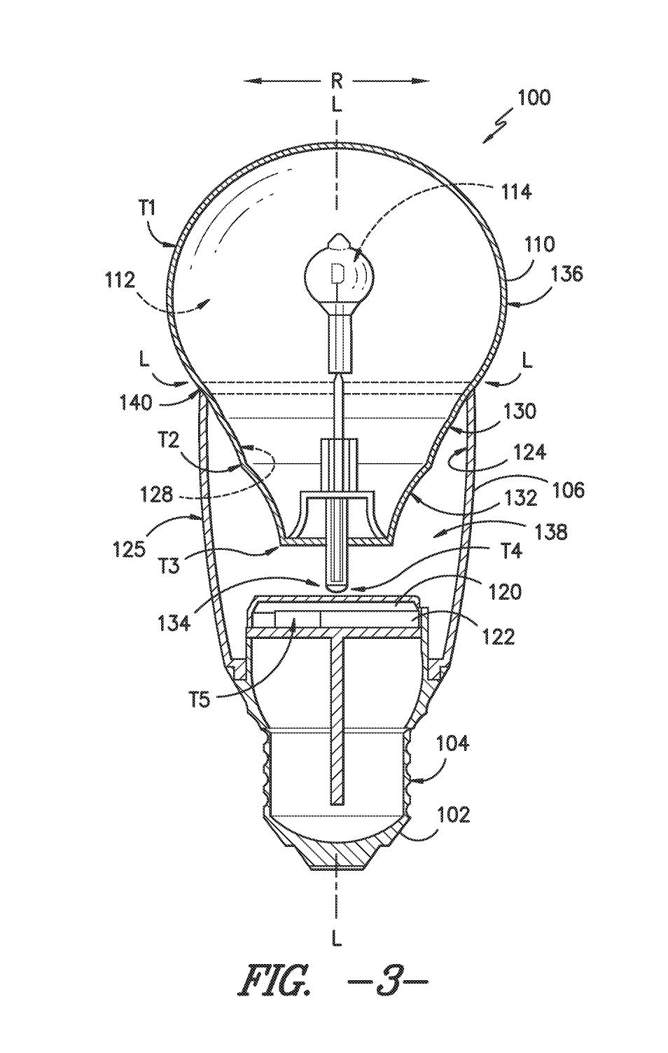

FIG. 3 provides a cross-sectional view of another exemplary embodiment of thermally protected lamp assembly 100 of the present invention where reference numerals identical to the embodiment of FIGS. 1 and 2 indicate the same or similar features. However, housing 106 is shaped in a manner that creates a larger interior compartment 138. For example, the inside surface 124 of housing 106 is spaced apart along radial direction R from the base portion 132 of bulb 110. Additionally, for the embodiment of FIG. 3, the insulating element or thermal shield 120 is constructed as a plate or cap positioned over electronics package 122. Other configurations may be used as well.

FIG. 4 provides a plot of temperature as measured during operation of a lamp constructed similar to the embodiment of FIG. 3. Temperature measurements were taken at locations T1, T2, T3, and T4 as also shown in FIG. 3. As shown, T1 is located near the widest part of body portion 136. T2 is located near the base portion 132 of bulb 110. T3 is located nearest to the electronics package on the bottom portion of bulb 110. T4 is located at the end of the exhaust pipe near tube seal 134.

Data line 300 (denoted by diamonds in FIG. 4) represents the temperature at the measured locations for a bulb that was both sealed and evacuated. Data line 302 (denoted by squares) represents the temperature at the measured locations for an unsealed bulb. Data line 304 (denoted by triangles) represents the temperature at the measured locations for a bulb that was sealed, evacuated, and included a mirror-like reflective coating along the bottom portion of the bulb as described above. Data line 306 (denoted by “x” marks in FIG. 4) represents the temperature at the measured locations for a bulb that was sealed but not evacuated.

As shown by FIG. 4, the lamp assembly having a sealed and evacuated bulb (line 300) experienced lower temperatures at locations T2 and T3. The lamp assembly having a sealed, evacuated bulb and a reflective coating (line 304) experienced lower temperatures at locations T2, T3, and T4. Thus, the effectiveness of the thermal features described above is shown.

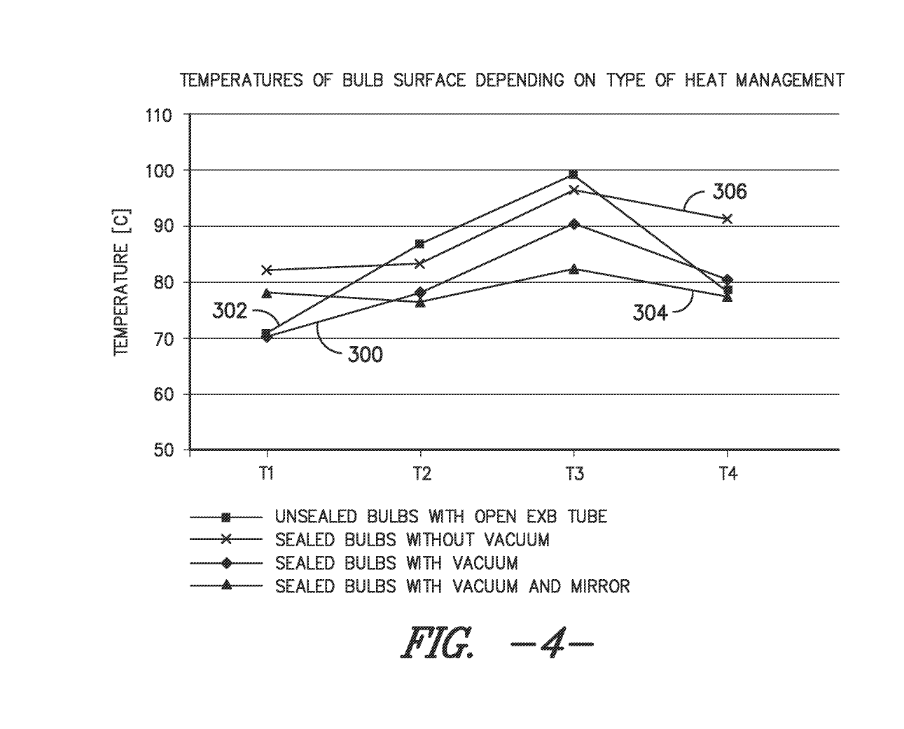

FIG. 5 illustrates the temperature measurements taken at location T5 for a lamp assembly similar to the embodiment of FIG. 3 with a sealed but not evacuated bulb (datum 500), with a sealed and evacuated bulb (datum 502), and with an evacuated and sealed bulb that also included a reflective mirror constructed with barium oxide (datum 504). Again the evacuated bulbs experienced lower temperatures during operation than the non-evacuated bulb.

It should be understood that the present invention may be used with a variety of lamp assemblies of different types and/or styles. For example, the present invention may be used where the base is E14, E27, B15, or B22d. Other base types may be used as well.

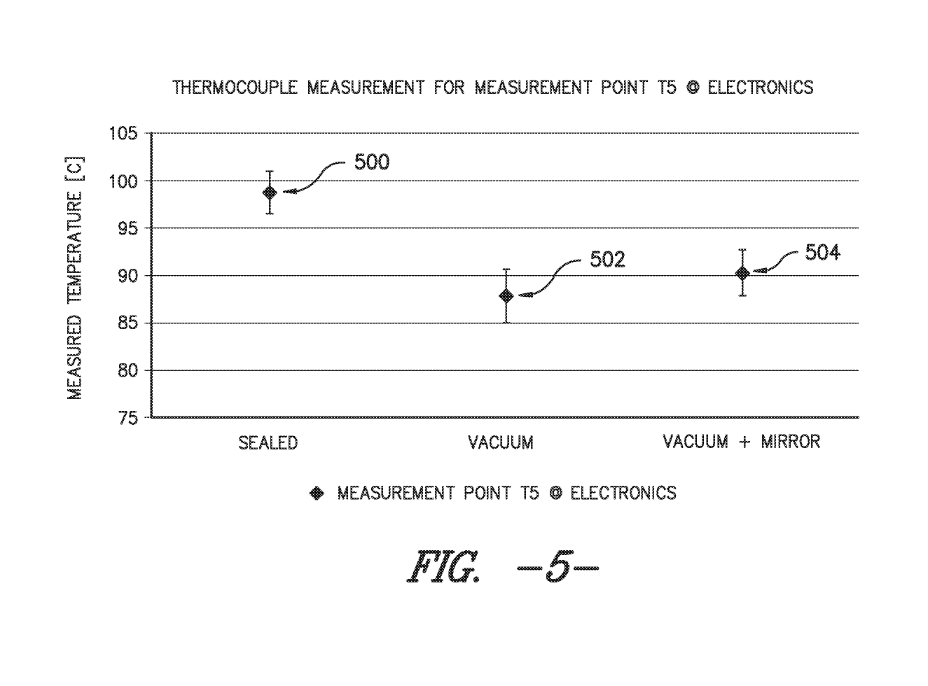

FIGS. 6, 7, 8, 9, and 10 provide additional exemplary embodiments of a lamp assembly 100 of the present invention. Referring to FIG. 6, lamp assembly 100 includes a bulb 110 supported directly by thermal shield 120, which in turn is connected with housing 106. As with previous embodiments, thermal shield 120 provides protection for electronics that may be located in housing 106. Reflective coatings may be provided e.g., on bulb 110 and housing 106 as previously described.

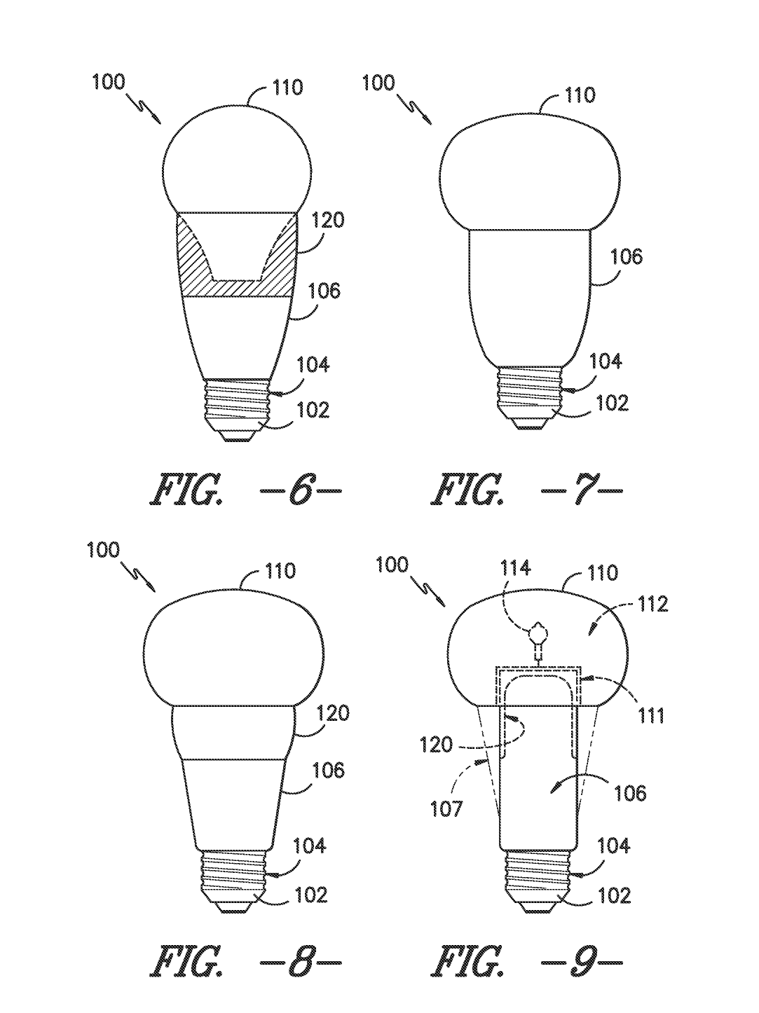

FIG. 7 provides another exemplary embodiment of lamp assembly 100 illustrating a bulb 110 and housing 106 having significantly different shapes from the previously illustrated embodiments. Other shapes and configurations may be used as well—it being understood that the figures provide examples only. For example, FIG. 8 illustrates another exemplary embodiment of a lamp assembly 100 in which bulb 100 is supported directly by thermal shield 120, which in turn is connected with housing 106.

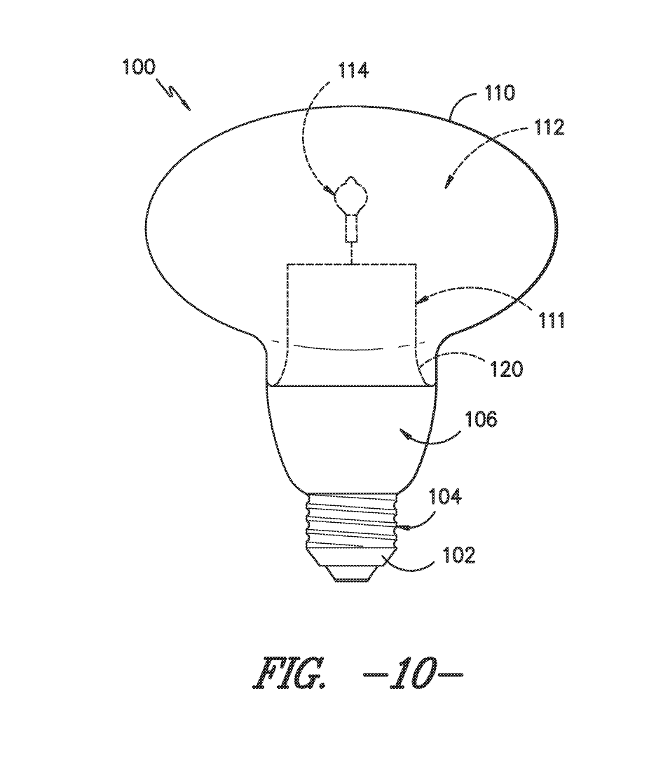

For the exemplary embodiment of FIG. 9, bulb 110 is supported by a housing 106—at least a portion of which extends into an internal cavity 111 of bulb 110. Light emitting device 114 is positioned within the enclosed and evacuated space 112 provided by bulb 110. Optionally, a thermal shield 120 can be provided to protect electronics within housing 106. Also, an aesthetic shield 107 may be provided extending around a portion of housing 106 near bulb 110 as shown. Reflective coatings may also be used as previously described.

FIG. 10 illustrates another exemplary embodiment where bulb 110 is supported by housing 106. An internal cavity 111 is formed by bulb 110. Unlike the embodiment of FIG. 9, housing 106 does not extend into cavity 111. Light emitting device 114 is positioned within the enclosed and evacuated space 112 outside of cavity 111. Optionally, a thermal shield 120 can be provided to protect electronics within housing 106.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A lamp assembly, comprising:
a base;
a housing positioned proximate to the base, the housing having an internal surface and defining an interior compartment;
a bulb supported by the housing and defining an enclosed and evacuated space;
a light emitting device positioned within the enclosed space of the bulb; and
an electrical unit received into the interior compartment of the housing and located external to the evacuated space of the bulb, the electrical unit connected electrically with the light emitting device.

2. A lamp assembly as in claim 1, further comprising a reflective coating positioned along the internal surface of the housing and configured for reflecting energy from the light emitting device away from the electrical unit.

3. A lamp assembly as in claim 1, wherein the bulb has a base portion received into the interior compartment of the housing and the lamp assembly further comprises a reflective coating positioned on the base portion of the bulb and configured for reflecting energy from the light emitting device away from the electrical unit.

4. A lamp assembly as in claim 3, wherein the reflective coating on the base portion of the bulb does not extend outside of the housing.

5. A lamp assembly as in claim 3, wherein the reflective coating comprises a material that reflects infrared radiation created by the light emitting device.

6. A lamp assembly as in claim 3, wherein the reflective coating comprises one or more of aluminum, tin, aluminum oxide, tin dioxide, silver, boron nitride, polycarbonate, polyethylene, polyethylene terephthalate, or polytetrafluorethylene.

7. A lamp assembly as in claim 1, wherein the evacuated space is at a pressure in the range of about 100 mbar or less.

8. A lamp assembly as in claim 1, wherein the bulb is hermetically sealed.

9. A lamp assembly as in claim 1, further comprising a thermal shield positioned between the light emitting device and the electrical unit and configured for insulating the electrical unit from the light emitting device.

10. A lamp assembly as in claim 1, wherein the light emitting device comprises a halogen lamp, incandescent lamp, a discharge lamp, or a high intensity discharge lamp.

11. A lamp assembly as in claim 1, wherein the electrical unit comprises an electrical transformer.

12. A thermally protected lamp assembly, comprising:
a housing defining an interior compartment;
a bulb having a base portion and a body portion, the bulb defining an enclosed volume that is evacuated, the base portion of the bulb received within the interior compartment of the housing;
an electronics package received into the interior compartment of the housing and located outside of the enclosed volume of the bulb; and
a light emitting device positioned within the enclosed volume of the bulb and connected with the electronics package.

13. A thermally protected lamp assembly as in claim 12, further comprising a reflective coating positioned on the base portion of the bulb and configured for reflecting radiant energy from said light emitting device.

14. A thermally protected lamp assembly as in claim 13, wherein the reflective coating is located on an interior surface of the bulb and is shaped to reflect radiant energy from the light emitting device away from the electronics package.

15. A thermally protected lamp assembly as in claim 13, further comprising an insulating element located between the bulb and the light emitting device so as to thermally protect the electronics package from energy transmitted by said light emitting device.

16. A thermally protected lamp assembly as in claim 12, wherein the housing has an interior surface, and further comprising a reflective coating located on the interior surface of the housing and configured for reflecting radiant energy from the light emitting device.

17. A thermally protected lamp assembly as in claim 12, wherein the housing comprises a reflective polymer.

18. A lamp assembly, comprising:
a bulb defining an enclosed and evacuated space;
a housing positioned proximate to the bulb, the housing having an interior compartment;
a base connected with the housing;
a lighting emitting device positioned within the bulb so as to project light through the enclosed and evacuated space; and
an electrical unit received into the interior compartment of the housing and located external to the enclosed and evacuated space of the bulb, the electrical unit connected electrically with the light emitting device.

19. A lamp assembly as in claim 18, wherein the bulb defines an internal cavity into which at least a portion of the housing is received.

20. A lamp assembly as in claim 18, further comprising a thermal shield positioned between the bulb and the electrical unit.
